(19) United States
(12) Patent Application Publication
(10) Pub. No.: US 2025/0356210 A1
(43) Pub. Date: Nov. 20, 2025

(54) Calibrated Distillation

(71) Applicant: Google LLC, Mountain View, CA (US)

(72) Inventor: Gil Shamir, Sewickley, PA (US)

(21) Appl. No.: 18/870,846

(22) PCT Filed: Jun. 3, 2022
(86) PCT No.: PCT/US2022/032041

§ 371 Date: Dec. 2, 2024

(51) Int. Cl. G06N 3/096

(52) U.S. Cl. CPC G06N 3/096

(57) ABSTRACT

Provided are techniques for the calibration of distillation learning from a teacher model to a student model. Specifically, the present disclosure proposes systems and methods that provide convergence with both high quality and speed. That is, example proposed systems both enable the distillation loss to be minimized at the probability mean value in the probability domain of the teacher's predictions distributions while also providing a loss that is nicely (e.g., symmetrically and/or strongly) convex around an optimum in the logit and/or probability domains (e.g., including far from the minimum) to encourage fast convergence of gradient based methods (e.g., irrespective of distance from the minimum).

### FIELD

The present disclosure relates generally to machine learning. More particularly, the present disclosure relates to techniques for the calibration of distillation learning from a teacher model to a student model.

### BACKGROUND

In machine learning, knowledge distillation can refer generally to the process of transferring knowledge (e.g., via distillation training) from a teacher model to a student model. Typically, though not necessarily, the teacher model will be larger (e.g., in terms of number of parameters) than the student model. In particular, while large models (such as very deep neural networks or ensembles of many models) have higher knowledge capacity than small models, this capacity might not be fully utilized or required in all circumstances. For example, as smaller models are less expensive to evaluate, they can be deployed on less powerful hardware (such as a mobile device). More generally, student models can be designed to be simpler, to train faster, and/or to be deployable subject to deployment (e.g., system constrained) limitations. Teacher models do not have to obey such limitations and can spend more time training. Thus, there are various situations in which knowledge distillation from a teacher model to a student model can provide benefits.

### SUMMARY

Aspects and advantages of embodiments of the present disclosure will be set forth in part in the following description, or can be learned from the description, or can be learned through practice of the embodiments.

One example aspect of the present disclosure is directed to a computing system to perform distillation training with improved computational efficiency. The computing system includes: one or more processors; a teacher model comprising a teacher model body, a teacher logit head, and a teacher prediction head, wherein the teacher model body is configured to process an input to generate a teacher intermediate representation, wherein the teacher logit head is configured to process the teacher intermediate representation to generate teacher logit values, and wherein the teacher prediction head is configured to process the teacher logit values to generate teacher probability values; a student model comprising a student model body, a first student logit head, a second student logit head, and a student prediction head, wherein the student model body is configured to process an input to generate a student intermediate representation, wherein the first student logit head is configured to process the student intermediate representation to generate first student logit values, wherein the second student logit head is configured to process the student intermediate representation to generate second student logit values, and wherein the student prediction head is configured to process the first student logit values and the second student logit values to generate student probability values; and one or more non-transitory computer-readable media that collectively store instructions that, when executed by the one or more processors, cause the computing system to perform operations. The operations include: evaluating a first loss function based on the teacher logit values and the first student logit values; modifying one or more parameters of at least the first student logit head based on the first loss function; evaluating a second, different loss function based on the teacher probability values and the student probability values; and modifying one or more parameters of at least the second student logit head based on the second loss function.

Another example aspect of the present disclosure is directed to one or more non-transitory computer-readable media that collectively store: a machine-learned student model, wherein: the machine-learned student model comprises a student model body, a first student logit head, a second student logit head, and a student prediction head, the student model body is configured to process an input to generate a student intermediate representation, the first student logit head is configured to process the student intermediate representation to generate first student logit values, the second student logit head is configured to process the student intermediate representation to generate second student logit values, the student prediction head is configured to process the first student logit values and the second student logit values to generate student probability values, the first student logit head has been trained using a first loss function that evaluates the first student logit values and teacher logit values generated by a teacher model, and the second student logit head has been trained using a second loss function that evaluates the student probability values and teacher probability values generated by the teacher model; and instructions for running the machine-learned student model to process an input to generate the student probability values.

Another example aspect of the present disclosure is directed to a computing system to perform distillation training with improved computational efficiency, the computing system includes: one or more processors; a teacher model comprising a teacher model body, a teacher logit head, and a teacher prediction head, wherein the teacher model body is configured to process an input to generate a teacher intermediate representation, wherein the teacher logit head is configured to process the teacher intermediate representation to generate teacher logit values, and wherein the teacher prediction head is configured to process the teacher logit values to generate teacher probability values; a plurality of student models, wherein each student model comprises a student model body, a first student logit head, and a second student logit head, wherein the student model body is configured to process an input to generate a student intermediate representation, wherein the first student logit head is configured to process the student intermediate representation to generate first student logit values, wherein the second student logit head is configured to process the student intermediate representation to generate second student logit values; a student ensemble prediction head configured to generate student probability values from the plurality of the first student logit values and the plurality of the second student logit values from the plurality of student models; and one or more non-transitory computer-readable media that collectively store instructions that, when executed by the one or more processors, cause the computing system to perform operations. The operations include, for each student model of the plurality of student models: evaluating a first loss function based on the teacher logit values and the first student logit values; modifying one or more parameters of at least the first student logit head based on the first loss function; evaluating a second, different loss function based on the teacher probability values and the student probability values; and modifying one or more parameters of the second student logit head of each student model based on the second loss function.

Another example aspect of the present disclosure is directed to a computing system to perform distillation training with improved computational efficiency. The computing system includes: one or more processors; a teacher model comprising a teacher model body, a first teacher scoring head, and a second teacher scoring head, wherein the teacher model body is configured to process an input to generate a teacher intermediate representation, wherein the first teacher scoring head is configured to process the teacher intermediate representation to generate first teacher scoring values in a first scoring domain, and wherein the second teacher scoring head is configured to process the first teacher scoring values to generate second teacher scoring values in a second scoring domain, wherein the second scoring domain corresponds to an objective of the teacher model; a student model comprising a student model body, a first student scoring head, a second student scoring head, and a third student scoring head, wherein the student model body is configured to process an input to generate a student intermediate representation, wherein the first student scoring head is configured to process the student intermediate representation to generate first student scoring values in the first scoring domain, wherein the second student scoring head is configured to process the student intermediate representation to generate second student scoring values in the first scoring domain, and wherein the third student scoring head is configured to process the first student scoring values and the second student scoring values to generate third student scoring values in the second scoring domain; and one or more non-transitory computer-readable media that collectively store instructions that, when executed by the one or more processors, cause the computing system to perform operations. The operations include evaluating a first loss function based on the first teacher scoring values and the first student scoring values; modifying one or more parameters of at least the first student scoring head based on the first loss function; evaluating a second, different loss function based on the second teacher scoring values and the third student scoring values; and modifying one or more parameters of at least the second student scoring head based on the second loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a graphical diagram of an example forward pass during an example calibrated distillation training approach according to example embodiments of the present disclosure.

FIG. 2 illustrates a graphical diagram of an example backward pass during an example calibrated distillation training approach according to example embodiments of the present disclosure.

FIG. 3 illustrates a graphical diagram of an example backward pass during an example calibrated distillation training approach according to example embodiments of the present disclosure.

FIG. 4 illustrates a graphical diagram of an example forward pass during inference according to example embodiments of the present disclosure.

FIGS. 5A-C illustrate graphical diagrams of an example calibrated distillation training approach simultaneously applied to multiple student models according to example embodiments of the present disclosure.

FIG. 6A depicts a block diagram of an example computing system according to example embodiments of the present disclosure.

FIG. 6B depicts a block diagram of an example computing device according to example embodiments of the present disclosure.

FIG. 6C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to techniques for the calibration of distillation learning from a teacher model to a student model. Specifically, the present disclosure proposes systems and methods that provide convergence with both high quality and speed. That is, the proposed approach can enable the loss to converge quickly and then be calibrated to converge to the correct optimum. For example, proposed systems both enable the distillation loss to be minimized at the probability mean value in the probability domain of the teacher's predictions distributions (e.g., as a proper scoring rule) while also providing a loss that is nicely (e.g., symmetrically and/or strongly) convex around an optimum in the logit and/or probability domains (e.g., including far from the minimum) to encourage fast convergence of gradient based methods (e.g., irrespective of distance from the minimum). As one example, convergence to the mean in probability is best when optimizing for logistic loss. However, the method described can be applied to other losses as well to ensure convergence to the correct minimum point (whichever it may be) with fast convergence speed by ensuring a strongly or nicely convex loss. The proposed approach has particular benefit when applied to the teacher's distribution over examples that appear the same to the student.

The proposed systems can facilitate the benefits described above by performing the distillation training according to a two stage (or pathway) approach. In a first stage or pathway, a distillation loss that gives good convergence can be used, such as L1, L2, or Quantile-Regression-based distillation. For example, this loss can be applied in the logit space between the teacher and a first head of the student. In a second stage, the prediction can be calibrated towards the desired optimum, for example, by applying calibration with cross entropy loss. For example, this loss can be applied in the probability space between the teacher and the student, where the student probabilities have been generated at least in part using a second, different head of the student. The two stages can be applied together in both forward and backward paths.

More particularly, multiple losses and configurations have been proposed and considered for knowledge distillation. One major aspect of distillation is the enhanced ability of the teacher to express examples. Specifically, due to features that only the teacher has, the student can only express a single prediction to families of examples. The teacher, on the other hand, has access to many feature/parameter dimensions to which the student has no access. This allows the teacher to produce distributions of prediction values to families of examples, which according to the student are summarized to a single prediction.

Selection of an appropriate loss is important to improve the quality and convergence speed of distillation. Specifically, distillation loss should be minimized at the probability mean value in the probability domain of the teacher's predictions distribution on the family of examples seen as one by the student to minimize cross entropy loss objectives. If a different loss is optimized, there may be a different point where the loss on a distribution is minimized. In addition, the loss should be nicely (e.g., preferably symmetrically and even more preferably strongly) convex around any such optimum in logit and probability domains, including far from the minimum, to encourage fast convergence of gradient based methods whether we are closer or farther from the minimum. However, none of the known or practiced methods in the art that attempt to use a single loss fully satisfy both properties.

In view of the failure of existing approaches to satisfy both of these properties, the present disclosure provides systems and methods that meet the above described requirements using an approach that operates over two stages (e.g., which may correspond to two loss pathways flowing through two different loss heads).

In a first stage, a training system can apply a first distillation loss (e.g., square loss) in logit space to allow for fast convergence, but not necessarily to the correct minimum (e.g., converging to the logit mean, which for many skewed teacher distributions is farther from the origin than the probability mean).

In a second stage, the training system calibrates the prediction with a second distillation loss (e.g., cross entropy loss) to pull the minimum towards the correct mean (e.g., in probability domain). The calibration loss may not be as nicely convex, but because it acts on top of a loss that generates faster convergence to a minimum usually close to the one desired, it only needs to refine the prediction towards the desired minimum.

The first and second stages can be performed sequentially or simultaneously (e.g., in parallel). The proposed system is general and can use various losses in both stages. For example, L1 or Quantile Regression (QR) distillation losses can be used in the first stage.

The present disclosure provides a number of technical effects and benefits. As one example, performing distillation learning with the proposed approach can improve the efficiency of training (e.g., enable faster convergence using fewer training cycles or processing iterations). This can result in a reduced consumption of computational resources such as processor usage, memory usage, and/or network bandwidth usage.

As another example technical effect and benefit, models trained according to the proposed approach can provide superior results such as more accurate results. This can improve the performance of the model and its implementing computing system relative to a number of different tasks. Thus, the systems and methods of the present disclosure can improve the functioning of a computer.

As yet another example technical effect and benefit, the present disclosure enables the more common use of student models which have been distilled from teacher models. Often, student models are smaller (e.g., in storage size) and/or faster to run (e.g., require less computation such as fewer processor operations). This can result in a reduced consumption of computational resources such as processor usage, memory usage, and/or network bandwidth usage. Teacher models can be trained offline once, and used for multiple student models that are to be deployed, or that are experimented with.

With reference now to the Figures, example embodiments of the present disclosure will be discussed in further detail.

### Example Discussion of Distillation Losses

Example implementations of the present disclosure are applicable to a system where the teacher signal is distilled to the student signal, and we specifically want to achieve minimum cross-entropy logarithmic loss for the student model on its test data. Let tᵢ denote the teacher's prediction on example i in logit domain, and sᵢ the student's prediction on the same example. One possible approach is direct label distillation. However, tᵢ and sᵢ can also express logit pair differences used for ranking distillation. Let pᵢ^{t} be the teacher's prediction in probability domain, and pᵢ^{s} the student's for example i. For logistic regression, the signals in probability domain are related to those in logit domain with the Logistic (Sigmoid) function

$${\begin{matrix}{p}_{i}^{t} = σ ( {t}_{i} ) {=}^{Δ} \frac{1}{1 + exp ( - {t}_{i} )} , {p}_{i}^{s} = σ ( {s}_{i} ) {=}^{Δ} \frac{1}{1 + exp ( - {s}_{i} )} & ( 1 )\end{matrix}}_{}^{}$$

where sigma denotes the logistic function. For the binary logistic case, let yᵢ∈{0,1} be the true label of example i. Then, the logistic loss for the student prediction for example i is given by

$${L}_{i} ( {y}_{i} , {s}_{i} ) = - {y}_{i} log ( {p}_{i}^{s} ) - ( 1 - {y}_{i} ) log ( 1 - {p}_{i}^{s} ) \qquad ( 2 )$$

Distillation losses are defined between the teacher and the student signal, where in deep networks, backpropagation gradients typically but not always propagate only to the student's network and features, so that the student learns towards the teacher's predictions (and in many cases also together with learning towards the true label loss). Example descriptions herein focus only on the distillation losses towards the teacher's predictions.

Cross entropy distillation can be attained by applying distillation loss

$${L}_{i}^{d} ( {t}_{i} , {s}_{i} ) = - {p}_{i}^{t} log ( {p}_{i}^{s} ) - ( 1 - {p}_{i}^{t} ) log ( 1 - {p}_{i}^{s} ) \qquad ( 3 )$$

on the student prediction to align it with the teacher fractional label pᵢ^{t}. A temperature parameter gamma can be introduced for temperature cross-entropy logistic loss given by

$${L}_{i}^{d} ( {t}_{i} , {s}_{i} ) = \frac{γ}{1 + exp ( - {t}_{i} / γ )} log [ 1 + exp ( - {s}_{i} / γ ) ] + \frac{γ}{1 + exp ( {t}_{i} / γ )} log [ 1 + exp ( {s}_{i} / γ ) ] \qquad ( 4 )$$

The temperature essentially stretches or compresses the Sigmoid of both the teacher and the student with the same scaling, and is also used to scale the loss. The expression in (4) is a mathematical manipulation of (3) using (1) replacing pᵢ^{t} and pᵢ^{s} with the respective scaled Sigmoids.

Square loss uses the L2 norm of the differences. In logits, it is given by

$${L}_{i}^{d} ( {t}_{í} , {s}_{i} ) = {‖ {t}_{i} - {s}_{i} ‖}^{2} \qquad ( 5 )$$

and in probabilities, by

$${L}_{i}^{d} ( {p}_{i}^{t} , {p}_{i}^{s} ) = {‖ {p}_{i}^{t} - {p}_{i}^{s} ‖}^{2} \qquad ( 6 )$$

Similarly, the L1 norm distillation loss can be defined as

$${L}_{i}^{d} ( {t}_{i} , {s}_{i} ) = {‖ {t}_{i} - {s}_{i} ‖}_{\text{?}} = \vert {t}_{i} - {s}_{i} \vert \qquad ( 7 )$$

$$\text{?} \text{indicates text missing or illegible when filed}$$

Temperature scaled probit distillation loss can be defined with equation (3) (scaled by the temperature gamma), where the probabilities pᵢ^{t} and pᵢ^{s} are equal a normal Cumulative Density Function (CDF), with standard deviation that is equal the temperature. (This view can be similar to viewing the logistic prediction probability as the CDF value of the logit for a logistic distribution.) The probit probabilities are given by

$${p}_{\text{?}}^{\text{?}} = Φ ( \frac{{t}_{\text{?}}}{γ} ) = \frac{1}{2} [ erf ( \frac{{t}_{\text{?}}}{\sqrt{2} γ} ) + 1 ] , {p}_{\text{?}}^{\text{?}} Φ ( \frac{{s}_{\text{?}}}{γ} ) = \frac{1}{2} [ erf ( \frac{{s}_{\text{?}}}{\sqrt{2} γ} ) + 1 ] \qquad ( 8 )$$

$$\text{?} \text{indicates text missing or illegible when filed}$$

where Φ(·) is the standard normal CDF, and erf(·) is the standard error function, given by

$$erf ( x ) = \frac{2}{\sqrt{π}} {\int }_{0}^{x} {e}^{- {x}^{2}} dx \qquad ( 9 )$$

The Huber loss connects between square loss at and near the minimum and linear loss farther from the minimum. The tradeoffs between the two components are determined by the parameter beta. For distillation, the loss is given by

$${L}_{i}^{d ( H )} ( {t}_{i} , {s}_{i} ) {=}^{Δ} \{ \begin{matrix}\frac{1}{2} {( {t}_{í} , {s}_{i} )}^{2} & \vert {t}_{í} , {s}_{i} \vert \leq β \\ β ( \vert {t}_{í} , {s}_{i} \vert - \frac{1}{2} β ) & \vert {t}_{í} , {s}_{i} \vert > β\end{matrix} \qquad ( 10 )$$

A similar functional form can be used on pᵢ^{t} and pᵢ^{s} to distill in probability with Huber loss. The loss is closer to quadratic with a larger beta, and closer to L1 with a smaller beta.

Quantile Regression based distillation does not connect directly between the student signal belief sᵢ and that of the teacher. Instead, for each quantile τ in a set of quantile values {τ} a separate loss is created against the teacher's signal tᵢ. The loss is relative to a function q_{τ}(sᵢ). As an output of a deep network, q_{τ}(sᵢ) can be defined as

$${q}_{τ} ( {s}_{i} ) = {w}_{τ} {s}_{i} + {b}_{τ} \qquad ( 11 )$$

where w_{τ} and b_{τ} are a link weight and a bias which are also learned from the teacher signal tᵢ.

More generally, sᵢ can be some signal that is connected to q_{τ}(sᵢ) via matrices of link weights and bias vectors. For example, sᵢ can be a vector of some layer of the deep network (e.g., possibly the penultimate one connected to the output), and w_{τ} can be a vector of learned weights, with b_{τ} being a scalar bias. However, other configurations can be possible. The QR distillation loss is then defined as the sum over all assigned quantiles {τ}, given by

$${L}_{i}^{d ( QR )} ( {t}_{i} , {s}_{i} ) = {\sum }_{r ∈ \{ r \}} \{ ( 1 - τ ) \cdot I [ {t}_{i} < {q}_{τ} ( {s}_{i} ) ] \cdot [ {q}_{τ} ( {s}_{i} ) - {t}_{i} ] + τ \cdot I [ {t}_{i} > {q}_{τ} ( {s}_{i} ) ] \cdot [ {t}_{i} - {q}_{τ} ( {s}_{i} ) ] \} = {\sum }_{r ∈ \{ r \}} \{ ( 1 - τ ) \cdot ReLU [ {q}_{τ} ( {s}_{i} ) - {t}_{i} ] + τ \cdot ReLU [ {t}_{i} - {q}_{τ} ( {s}_{i} ) ] \} \qquad ( 12 )$$

where I(·) is the indicator function, and ReLU(·) is the Rectified Linear Unit ReLU(x)=max(x, 0).

Training for the distillation loss learns the parameters unique for the tau's quantile, w_{τ} and b_{τ} (or more general parameters if the network is defined differently). It also learns a student (logit) signal sᵢ, which can be an observed parameter, or a latent parameter to the internal belief of the network of the student's prediction of the example's logit. Using this loss yields a loss that is minimized at the median of the teacher's distribution if the set of quantiles {τ} is symmetric in the sense that if τ is included in the set, also 1−τ is. If {τ}={0.5}, the loss in (12) reduces to (a scaled version of) that in equation (7). With more quantiles the loss is smoother, or piecewise linear, with smaller jumps in the gradient between pieces. A similar variant to equation (12) can be used in the probability domain, replacing tᵢ and sᵢ by pᵢ^{t} and pᵢ^{s}, respectively.

The individual quantile loss components of QR distillation can be smoothed by using some smoother function, such as x\hat{ }2, [ReLU(x)]\hat{ }2, SmeLU, SmeLU_beta(x), swish(x), softplus(x), or others. With SmeLU

$$y = \{ \begin{matrix}0 ; & x \leq - β \\ \frac{{( x + β )}^{2}}{4 β} ; & \vert x \vert \leq β \\ x ; & x \geq β\end{matrix} \qquad ( 13 )$$

the QR distillation loss is given by

$${L}_{i}^{d ( SQR )} ( {t}_{i} , {s}_{i} ) = {\sum }_{r ∈ \{ r \}} \{ ( 1 - τ ) \cdot {SmeLU}_{β} [ {q}_{τ} ( {s}_{i} ) - {t}_{i} ] + τ \cdot {SmeLU}_{β} [ {t}_{i} - {q}_{τ} ( {s}_{i} ) ] \} \qquad ( 14 )$$

Using the smoother than ReLU function pushes the minimum away from the median towards the mean (in this case in the logit domain), if the two do not match for the teacher's distribution.

However, none of the loss functions described above give on their own the combination of desired properties of (1) fast minimization to an optimum at the teacher's prediction mean in the probability domain, and (2) a nicely convex loss surface on the whole range both in logit and in probability domains. While using Huber loss in logits (or smoothed QR regression distillation) for certain teacher prediction distributions may provide some compromise, these approaches need to be tuned differently for different example sets and different teacher distributions and it is not clear how this can be done universally.

### Example Calibrated Distillation Techniques

In view of the failure of existing loss approaches described above, the present disclosure proposes systems and methods that provide convergence with both high quality and speed. That is, example proposed systems both enable the distillation loss to be minimized at the probability mean value in the probability domain of the teacher's predictions distributions while also providing a loss that is nicely (e.g., symmetrically and/or strongly) convex around an optimum in the logit and/or probability domains (e.g., including far from the minimum) to encourage fast convergence of gradient based methods (e.g., irrespective of distance from the minimum).

The proposed systems can facilitate these benefits by performing the distillation training according to a two stage (or pathway) approach. In a first stage or pathway, a distillation loss that gives good convergence can be used, such as L1, L2, or QR distillation. For example, this loss can be applied in the logit space between the teacher and a first head of the student. In a second stage, the prediction can be calibrated towards the desired optimum, for example, by applying calibration with cross entropy loss. For example, this loss can be applied in the probability space between the teacher and the student, where the student probabilities have been generated at least in part using a second, different head of the student.

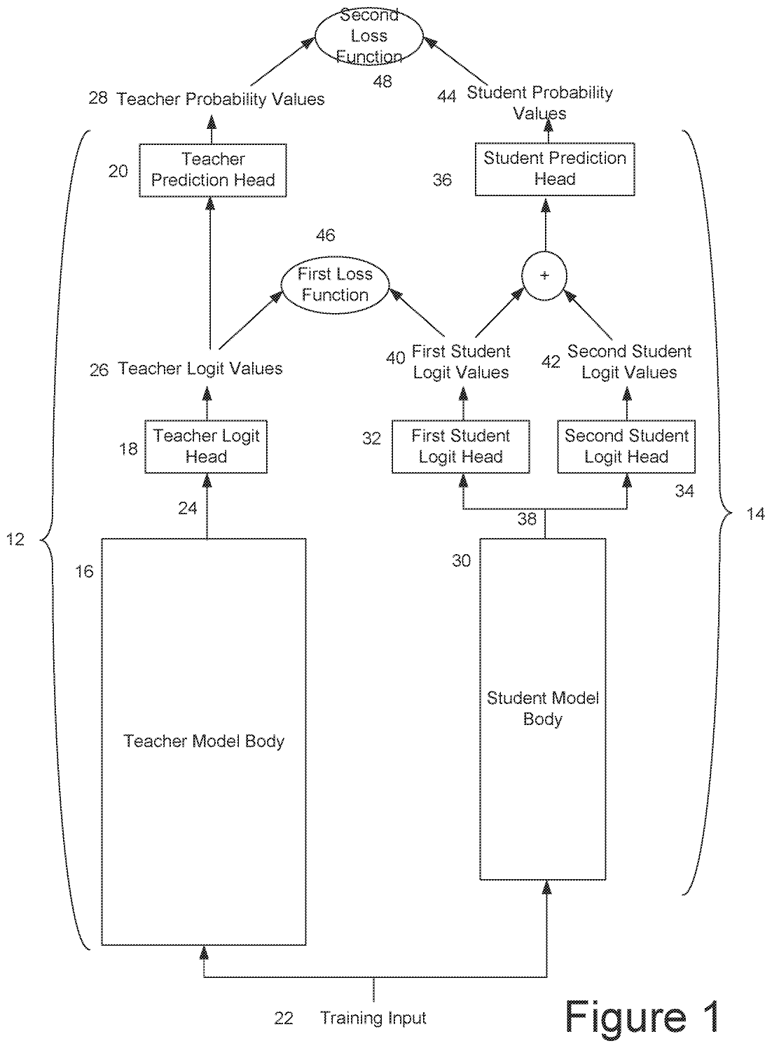

FIGS. 1-3 demonstrate example aspects of the proposed training approach. In a first stage, the faster converging loss can be applied to the top prediction of the student model towards the teacher. Then, the result can be passed to another loss, which observes the input signals to the first loss, as well as the prediction of the first loss, and uses its additional parameters to calibrate the prediction to the second loss.

In some implementations, calibration can control at the least the parameters that are link weights and biases that multiply the neuron activations of the penultimate deep network layer of the student as well as add the prediction of the first loss. More complex solutions can add more layers or parameters to the disposal of the calibration loss. Both loss heads can apply the distillation loss only or can also apply the loss relative to the true labels. Backpropagation can be stopped from the student to the teacher, but also from the calibrated prediction to the pre-calibrated one (e.g., which applies the fast converging loss). The network itself can usually be set to learn from the fast learning first loss, and backpropagation can, but does not have to, be blocked from the calibrated loss output. However, configurations that allow updates from either losses to the main student network can also be applied.

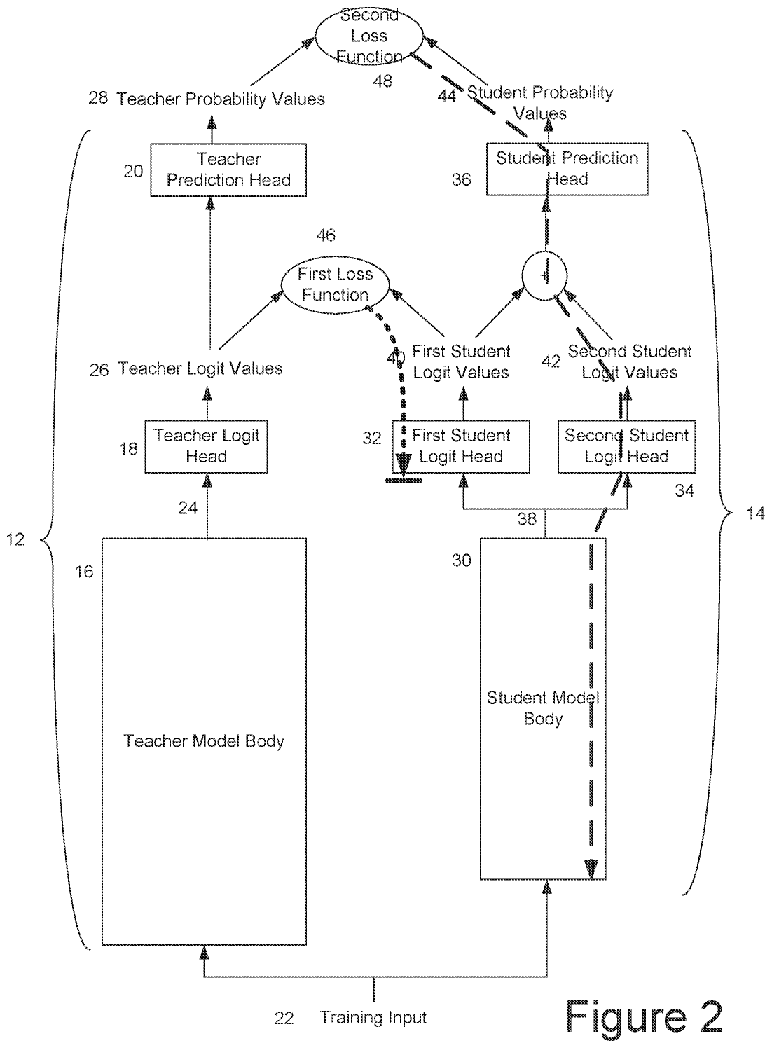

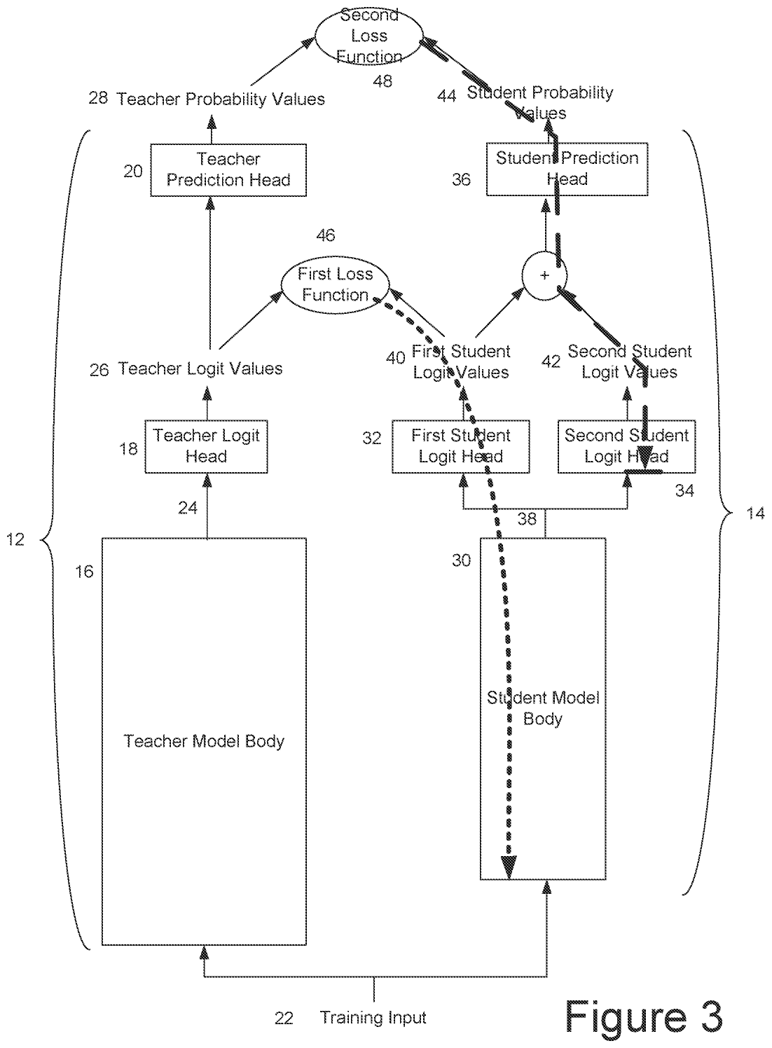

More particularly, FIG. 1 illustrates a graphical diagram of an example forward pass during an example calibrated distillation training approach; while FIG. 2 illustrates a graphical diagram of an example backward pass according to a first backpropagation scheme and FIG. 3 illustrates a graphical diagram of an example backward pass according to a second backpropagation scheme.

Referring first to FIG. 1, a distillation training scheme can be applied to distill knowledge from a teacher model 12 to a student model 14. The models 12 and 14 can include a number of heads. Each of these “heads” can be a single prediction operator connected to the model's preceding layer(s) and/or can include multiple hidden layers connected eventually to a single prediction operator, where weights and biases of theses layers are learnable. Thus, a “head” can include a single prediction operator (e.g., logit prediction operator, softmax operator, etc.) or multiple neural network layers which lead to such an operator.

The teacher model 12 can include a teacher model body 16, a teacher logit head 18, and a teacher prediction head 20. The teacher model body 16 can be configured to process an input (e.g., training input 22) to generate a teacher intermediate representation (shown at 24). The teacher logit head 18 can be configured to process the teacher intermediate representation 24 to generate teacher logit values 26. The teacher prediction head 20 can be configured to process the teacher logit values 26 to generate teacher probability values 28.

The student model 14 can include a student model body 30, a first student logit head 32, a second student logit head 34, and a student prediction head 36. The student model body 30 can be configured to process an input (e.g., the training input 22) to generate a student intermediate representation (shown generally at 38). The first student logit head 32 can be configured to process the student intermediate representation 38 to generate first student logit values 40. The second student logit head 34 can be configured to process the student intermediate representation 38 to generate second student logit values 42. The student prediction head 36 can be configured to process the first student logit values 40 and the second student logit values 42 to generate student probability values 44.

As one example, as illustrated in FIG. 1, the student model 14 can be configured to add the first student logit values 40 and the second student logit values 42 to generate combined logit values. The student prediction head 36 can be configured to process the combined logit values to generate the student probability values 44.

According to an aspect of the present disclosure, multiple loss functions can be used to train the two heads of 32 and 34 of the student model 14. Specifically, as illustrated in FIG. 1, a training system can evaluate a first loss function 46 based on the teacher logit values 26 and the first student logit values 40. The training system can evaluate a second, different loss function 48 based on the teacher probability values 28 and the student probability values 44.

Various loss functions can be used to satisfy the desired properties discussed herein. As examples, the first loss function 46 can be or include one of a square loss, a Huber loss, a smooth quantile loss, a quantile regression loss, or a smoothing loss. For example, the first loss function 46 can be an Lₚ loss function.

In general, in some implementations, the first loss function 46 can converge faster than the second loss function 48. In some implementations, the second loss function 48 can converge to a point that gives a minimum at some point proper to the loss used with respect to a distribution of teacher predictions. If cross entropy logistic loss is used in training the system, such a point is the mean in probability of the distribution of the teacher's predictions for families of examples that appear as a single example to the student, because of features that are used in the teacher's predictions but not for the student's. For example, the second loss function 48 can be one or both of symmetrically or strongly convex around a convergence optimum. As one example, the second loss function 48 can be or include a cross entropy loss function.

The two loss functions 46 and 48 can be used to train the student model 14 according to a number of different backpropagation approaches. A first example backpropagation approach is illustrated in FIG. 2. In FIG. 2, the first loss function 46 is used to modify or otherwise train the first student logit head 32 only (e.g., the backpropagation of loss function 46 is stopped at the base of the head 32). (The head can be a network that includes several hidden layers by itself.) However, the second loss function 48 can be used to modify or otherwise train both the second student logit head 34 and the student model body 30.

A second example backpropagation approach is illustrated in FIG. 3. In FIG. 3, the first loss function 46 is used to modify or otherwise train both the first student logit head 32 and the student model body 30. However, the second loss function 48 is used to modify or otherwise train only the second student logit head 34 (e.g., the backpropagation of loss function 48 is stopped at the base of the head 34).

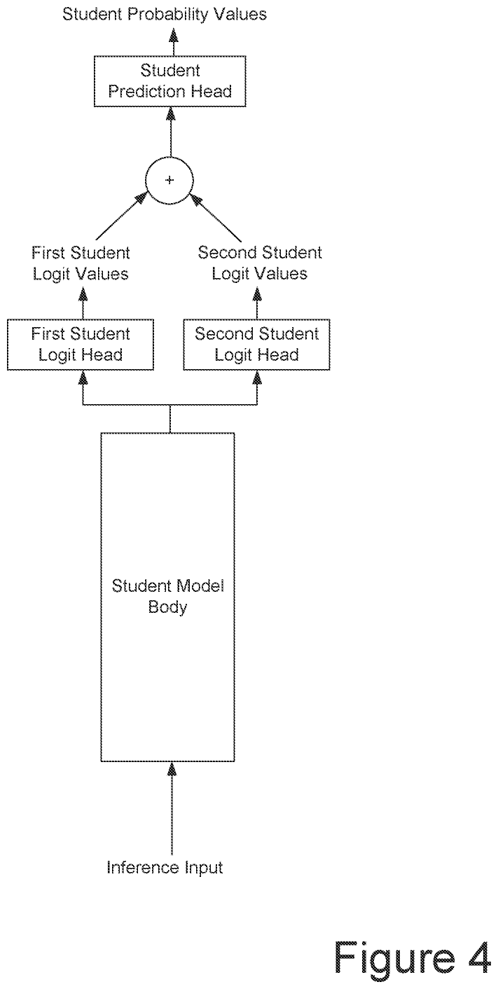

FIG. 4 illustrates a graphical diagram of an example forward pass during inference according to example embodiments of the present disclosure. In particular, the forward pass through the student model at the inference stage can adhere to the same approach as the forward pass through the student model during the training stage illustrated in FIG. 1, with the exception of the input being an inference input rather than a training input, and also with the exception that the teacher is not included in the inference.

One example application of the proposed method is for improving cross entropy logarithmic loss. Thus, in some implementations, the student prediction head can be or include a logistic function and the student probability values can be or include a logistic regression output.

Another example application is to pairs or lists of examples, where approaches such as the one proposed here can be applied with pairwise/listwise ranking losses. For ranking (e.g., of individual examples), applying a strong logit loss (e.g., such as square loss on logits, or losses such as QR distillation) may sometimes be sufficient for the ranking objective (e.g., which may not necessarily align with the cross-entropy loss).

Another aspect of the present disclosure relates to application of the proposed approach to ensembles of student models. More particularly, some systems use ensembles, where each component of the model trains independently, and applies distillation independently. Then, the final prediction averages (or uses mixtures of experts) the individual predictions.

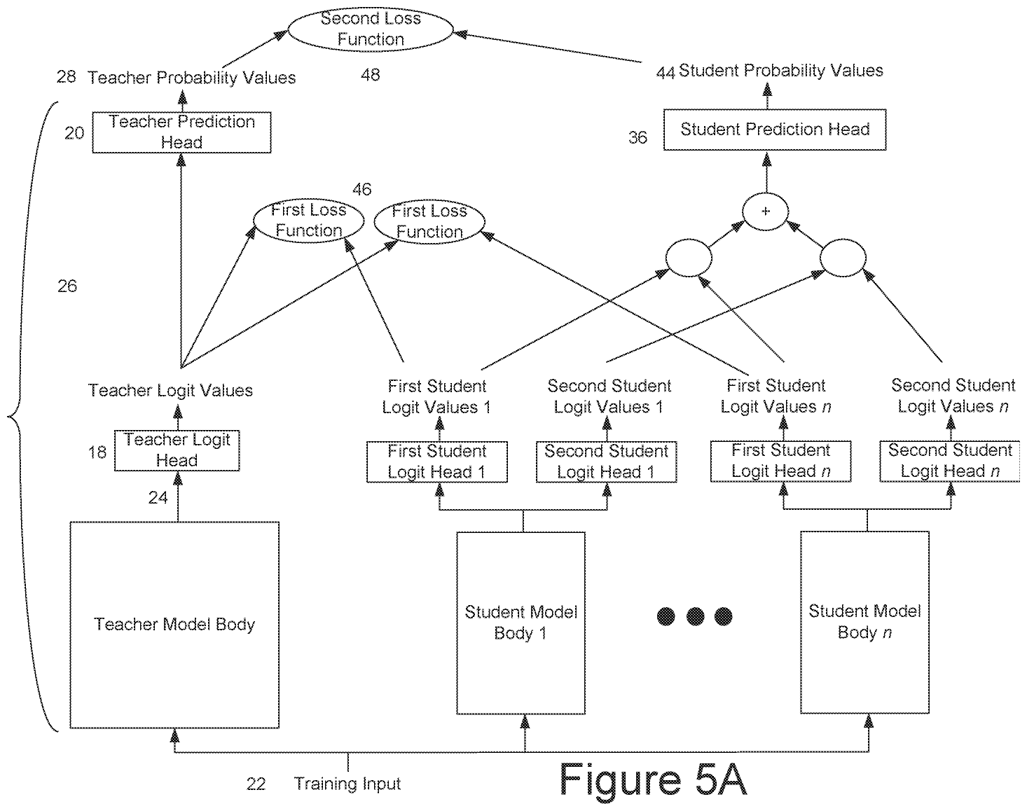

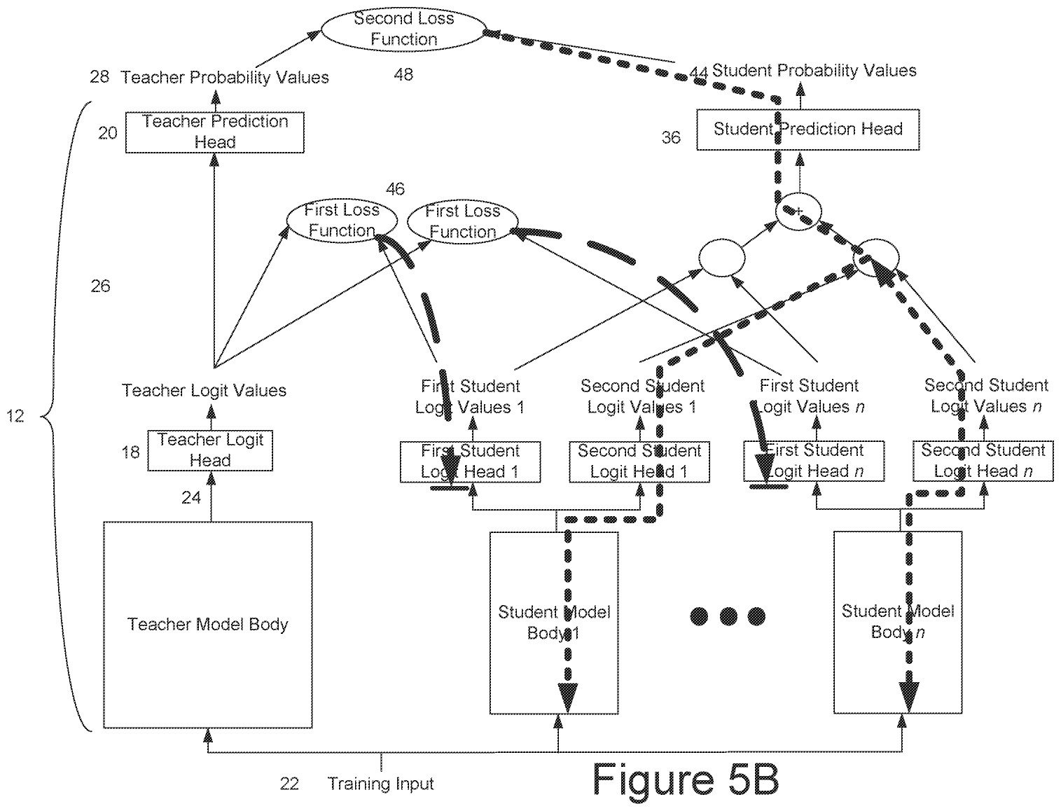

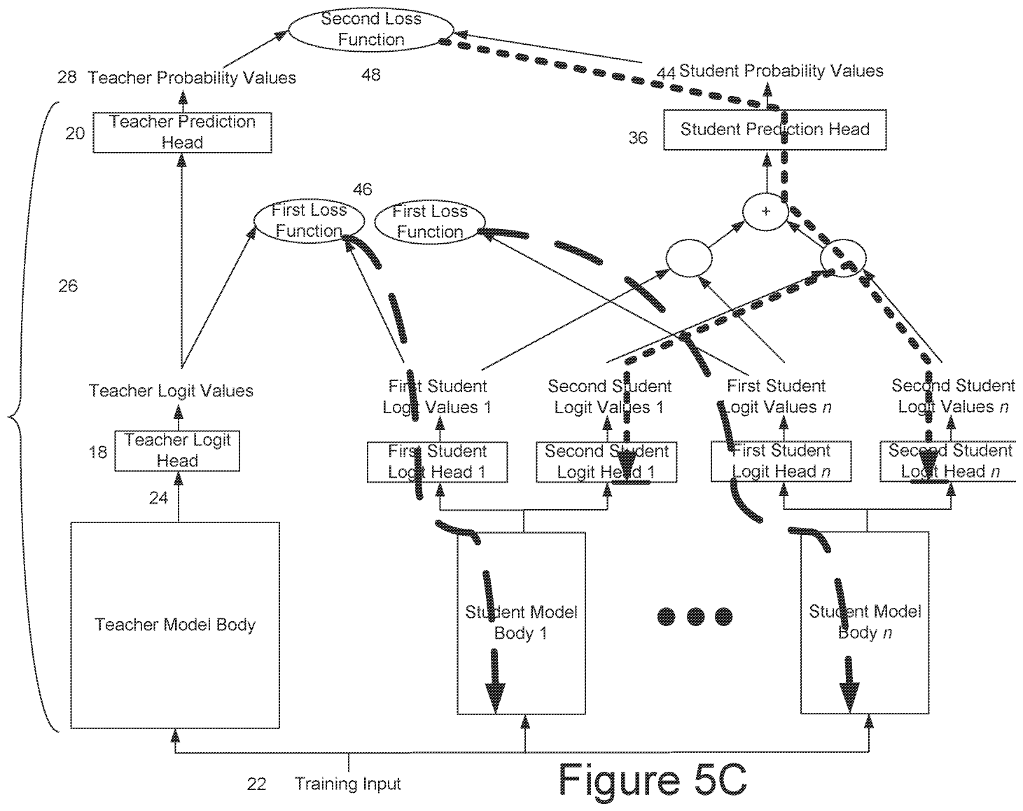

As illustrated in FIG. 5A, the proposed approach can be applied to ensembles of students as well. An ensemble can contain any number n of student models. In particular, for each student model in the ensemble, an independent distillation loss can be applied relative to the teacher's prediction. Specifically, the first loss function 46 (e.g., initial fast converging distillation loss) can be applied to each student model individually (e.g., at the first second logit head 1−n). However, the second calibration loss 48 can be applied on top of the ensemble average prediction. Specifically, comparing FIG. 1 with FIG. 5A, the second loss function 48, which applies the effect of the calibration loss can be taken on top of the ensemble, instead of a single component model to apply the calibration loss.

Thus, in the application to an ensemble, the first and second losses 46 and 48 can be backpropagated similar to as shown in FIGS. 2 and 3. For example, in some implementations, the second loss function 48 may be responsible only for updating the link weights and biases of matrix multiplication weights applied to the collection of top layers of the different ensemble components, which can be concatenated into one layer, or assembled individually and then summed to generate a final calibrated output. The circle in FIG. 5A that combines the second student logit values 1-n can then be interpreted as a concatenation of the hidden layers closest to the output of the ensemble components on top of which link weights are applied to generate a residue signal that calibrates the final prediction. A stop gradient operation can prevent updates from propagating to each of the networks constituting the student body, thereby preserving the updates of the calibration only to the link weights and biases of the calibration matrix multiplication. Then the final logit value can be summed together with the ensemble uncalibrated prediction to produce a calibrated prediction value. FIGS. 5B and 5C show two different example backpropagation approaches that can be applied.

Referring now collectively to FIGS. 1-5C, although example embodiments are described with reference to application of first and second loss functions at the logit and probability domains, alternative example implementations of the present disclosure can also be applied at other scoring domains such as regression domains which do not use probabilities.

### Example Devices and Systems

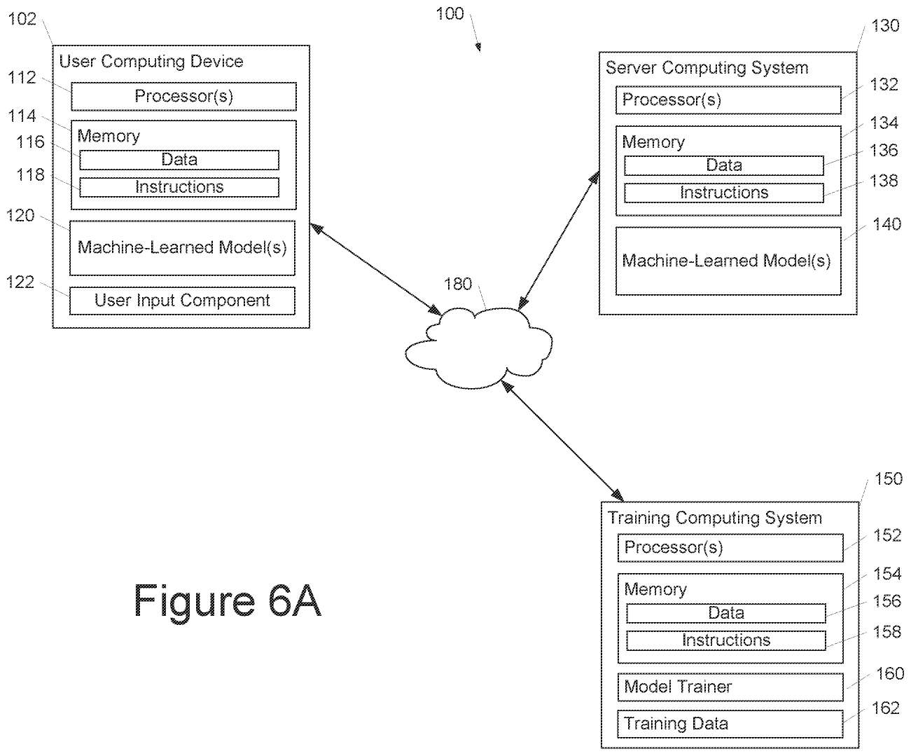

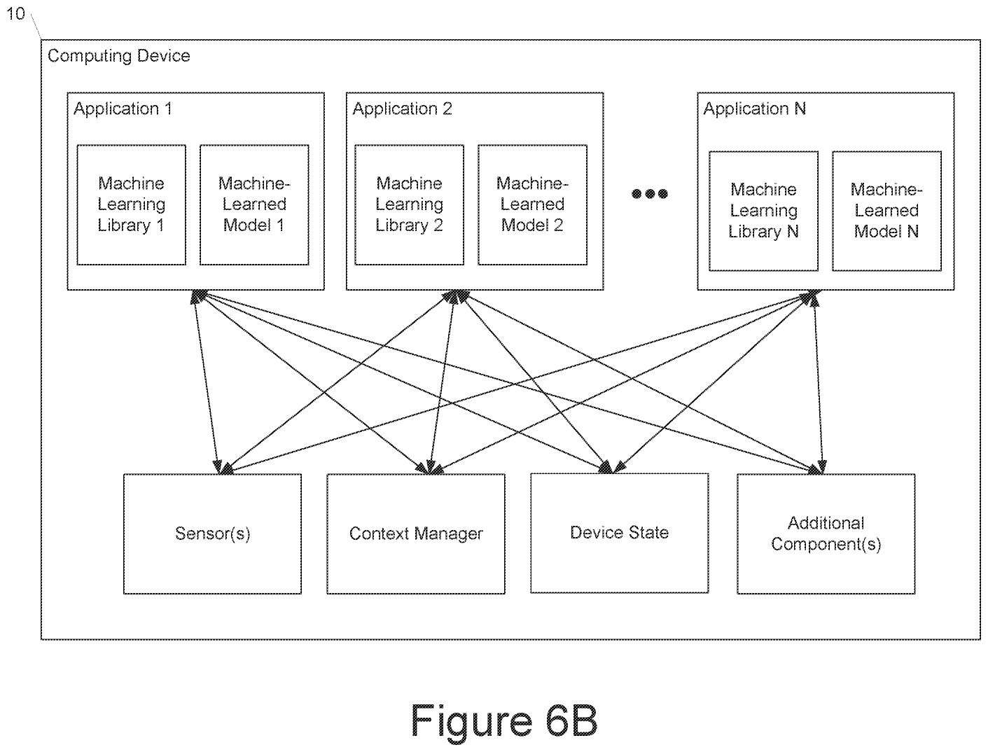

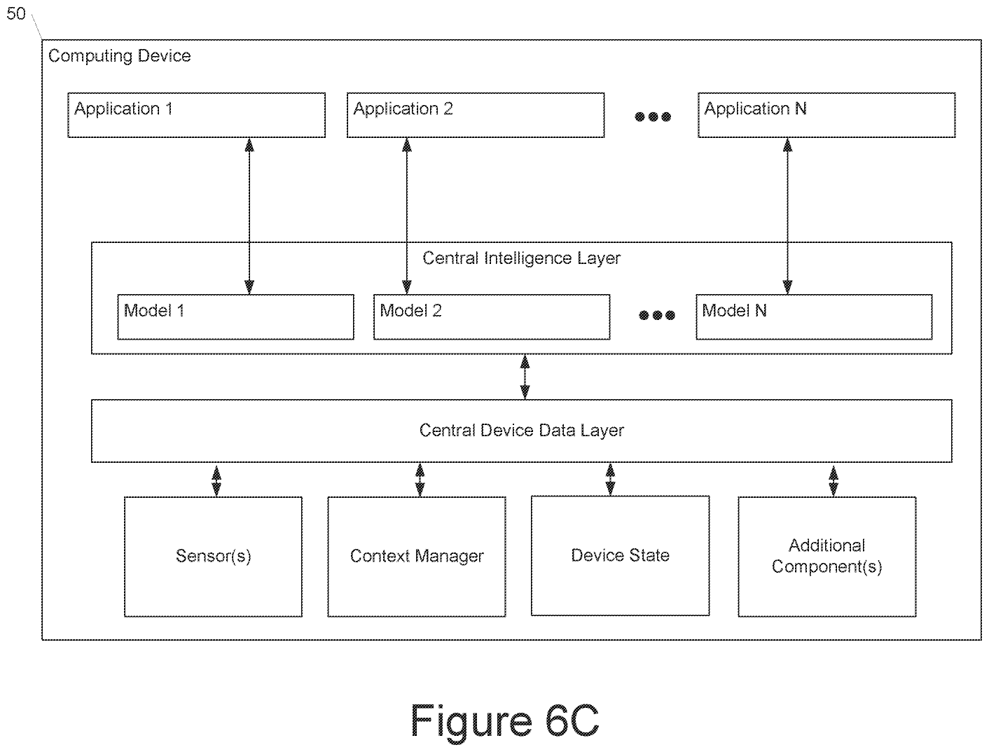

FIG. 6A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine learning models 120. For example, the machine learning models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine learning models 120 are discussed with reference to FIGS. 1-5.

In some implementations, the one or more machine learning models 120 can be received from the server computing system 130 over network 180, stored in the user computing device memory 114, and then used or otherwise implemented by the one or more processors 112. In some implementations, the user computing device 102 can implement multiple parallel instances of a single machine learning model 120 (e.g., to perform parallel distillation across multiple instances of teachers and/or students).

Additionally or alternatively, one or more machine learning models 140 can be included in or otherwise stored and implemented by the server computing system 130 that communicates with the user computing device 102 according to a client-server relationship. For example, the machine learning models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine learning models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine learning models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 6A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 6B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 6B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 6C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 6C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 6C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system to perform distillation training with improved computational efficiency, the computing system comprising:
one or more processors;
a teacher model comprising a teacher model body, a teacher logit head, and a teacher prediction head, wherein the teacher model body is configured to process an input to generate a teacher intermediate representation, wherein the teacher logit head is configured to process the teacher intermediate representation to generate teacher logit values, and wherein the teacher prediction head is configured to process the teacher logit values to generate teacher probability values;
a student model comprising a student model body, a first student logit head, a second student logit head, and a student prediction head, wherein the student model body is configured to process an input to generate a student intermediate representation, wherein the first student logit head is configured to process the student intermediate representation to generate first student logit values, wherein the second student logit head is configured to process the student intermediate representation to generate second student logit values, and wherein the student prediction head is configured to process the first student logit values and the second student logit values to generate student probability values; and
one or more non-transitory computer-readable media that collectively store instructions that, when executed by the one or more processors, cause the computing system to perform operations, the operations comprising:
evaluating a first loss function based on the teacher logit values and the first student logit values;
modifying one or more parameters of at least the first student logit head based on the first loss function;
evaluating a second, different loss function based on the teacher probability values and the student probability values; and
modifying one or more parameters of at least the second student logit head based on the second loss function.

2. The computing system of claim 1, wherein the first loss function comprises one of a square loss, a Huber loss, a smooth quantile loss, a quantile regression loss, or a smoothing loss.

3. The computing system of claim 1, wherein the first loss function comprises an Lₚ loss function.

4. The computing system of claim 1, wherein the first loss function converges faster than the second loss function.

5. The computing system of claim 1, wherein the second loss function comprises a proper scoring rule that is minimized at a point which is a desired statistic in a proper domain of a distribution of predictions produced by the teacher.

6. The computing system of claim 4, wherein one or both of the first loss function and the second loss function is one or both of symmetrically or strongly convex around a convergence optimum.

7. The computing system of claim 1, wherein the second loss function comprises a cross entropy loss function that gives a minimum at a predicted average probability over a distribution of predictions.

8. The computing system of claim 1, further comprising:
modifying one or more parameters of the student body based on the first loss function.

9. The computing system of claim 1, further comprising:
modifying one or more parameters of the student body based on the second loss function.

10. The computing system of claim 1, wherein:
the student model is configured to add the first student logit values and the second student logit values to generate combined logit values; and
the student prediction head is configured to process the combined logit values to generate the student probability values.

11. The computing system of claim 10, wherein the student prediction head comprises a logistic function and the student probability values comprise a logistic regression output.

12. The computing system of claim 1, wherein the teacher probability values are stored in a non-transitory computer readable medium and accessed from the non-transitory computer readable medium for training of the student model.

13. One or more non-transitory computer-readable media that collectively store:
a machine-learned student model, wherein:
the machine-learned student model comprises a student model body, a first student logit head, a second student logit head, and a student prediction head,
the student model body is configured to process an input to generate a student intermediate representation,
the first student logit head is configured to process the student intermediate representation to generate first student logit values,
the second student logit head is configured to process the student intermediate representation to generate second student logit values,
the student prediction head is configured to process the first student logit values and the second student logit values to generate student probability values,
the first student logit head has been trained using a first loss function that evaluates the first student logit values and teacher logit values generated by a teacher model, and
the second student logit head has been trained using a second loss function that evaluates the student probability values and teacher probability values generated by the teacher model; and
instructions for running the machine-learned student model to process an input to generate the student probability values.

14. The one or more non-transitory computer-readable media of claim 13, wherein:
the machine-learned student model is configured to add the first student logit values and the second student logit values to generate combined logit values; and
the student prediction head is configured to process the combined logit values to generate the student probability values.

15. The one or more non-transitory computer-readable media of claim 13 or 14, wherein the first loss function comprises a square loss function and the second loss function comprises a cross entropy loss function.

16. A computing system to perform distillation training with improved computational efficiency, the computing system comprising:
one or more processors;
a teacher model comprising a teacher model body, a teacher logit head, and a teacher prediction head, wherein the teacher model body is configured to process an input to generate a teacher intermediate representation, wherein the teacher logit head is configured to process the teacher intermediate representation to generate teacher logit values, and wherein the teacher prediction head is configured to process the teacher logit values to generate teacher probability values;
a plurality of student models, wherein each student model comprises a student model body, a first student logit head, and a second student logit head, wherein the student model body is configured to process an input to generate a student intermediate representation, wherein the first student logit head is configured to process the student intermediate representation to generate first student logit values, wherein the second student logit head is configured to process the student intermediate representation to generate second student logit values;
a student ensemble prediction head configured to generate student probability values from the plurality of the first student logit values and the plurality of the second student logit values from the plurality of student models;
one or more non-transitory computer-readable media that collectively store instructions that, when executed by the one or more processors, cause the computing system to perform operations, the operations comprising:
for each student model of the plurality of student models:
evaluating a first loss function based on the teacher logit values and the first student logit values;
modifying one or more parameters of at least the first student logit head based on the first loss function;
evaluating a second, different loss function based on the teacher probability values and the student probability values; and
modifying one or more parameters of the second student logit head of each student model based on the second loss function.

17. The computing system of claim 16, wherein the first loss function comprises one of a square loss, a Huber loss, a smooth quantile loss, a quantile regression loss, or a smoothing loss.

18. The computing system of claim 16, wherein the first loss function comprises an Lₚ loss function.

19. The computing system of claim 16, wherein the first loss function converges faster than the second loss function.

20. The computing system of claim 16, wherein the second loss function converges to a point that gives minimum loss with respect to a distribution of teacher predictions over examples that appear the same to the student model.

21. A computing system to perform distillation training with improved computational efficiency, the computing system comprising:
one or more processors;
a teacher model comprising a teacher model body, a first teacher scoring head, and a second teacher scoring head, wherein the teacher model body is configured to process an input to generate a teacher intermediate representation, wherein the first teacher scoring head is configured to process the teacher intermediate representation to generate first teacher scoring values in a first scoring domain, and wherein the second teacher scoring head is configured to process the first teacher scoring values to generate second teacher scoring values in a second scoring domain, wherein the second scoring domain corresponds to an objective of the teacher model;
a student model comprising a student model body, a first student scoring head, a second student scoring head, and a third student scoring head, wherein the student model body is configured to process an input to generate a student intermediate representation, wherein the first student scoring head is configured to process the student intermediate representation to generate first student scoring values in the first scoring domain, wherein the second student scoring head is configured to process the student intermediate representation to generate second student scoring values in the first scoring domain, and wherein the third student scoring head is configured to process the first student scoring values and the second student scoring values to generate third student scoring values in the second scoring domain; and
one or more non-transitory computer-readable media that collectively store instructions that, when executed by the one or more processors, cause the computing system to perform operations, the operations comprising:
evaluating a first loss function based on the first teacher scoring values and the first student scoring values;
modifying one or more parameters of at least the first student scoring head based on the first loss function;
evaluating a second, different loss function based on the second teacher scoring values and the third student scoring values; and
modifying one or more parameters of at least the second student scoring head based on the second loss function.

22. The computing system of claim 21, wherein the first scoring domain comprises a logit domain and wherein the second scoring domain comprises a probability domain.
